(19) United States
(12) Patent Application Publication
(10) Pub. No.: US 2006/0112021 A1
(43) Pub. Date: May 25, 2006

(54) Printing apparatus, control method thereof, and recording medium

(75) Inventor: Nobuhiki Maki, Shinagawa-ku (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/287,122

(22) Filed: Nov. 23, 2005

(30) Foreign Application Priority Data
Nov. 25, 2004 (JP) 2004-340810

(51) Int. Cl. G06Q 99/00

(52) U.S. Cl. 705/67

(57) ABSTRACT

A printing apparatus includes a generating unit generating first authentication information corresponding to inputted print data on the basis of predetermined information; a storage unit storing the first authentication information and the print data; an input accepting unit accepting an input of second authentication information; and a control unit determining, on the basis of the first authentication information, whether the inputted second authentication information corresponds to the first authentication information and, if the inputted second authentication information corresponds to the first authentication information, performing a print processing on the basis of the print data authentication, wherein the predetermined information includes specific information accompanying the print data.

### BACKGROUND OF THE INVENTION

1. Field of the Invention

The present invention relates to a printing apparatus, and, in particular, it relates to a secure print technology.

2. Description of the Related Art

With known technologies pertaining to secure print, authentication information such as a password is inputted, and when the information is justified, print data is extracted and a print processing is performed (see Japanese Patent Laid-Open Nos. 2003-345583 and 2003-345864).

In such known secure print systems, when a host computer transmits a print request and print data to a server on a network, the server generates authentication information (i.e., a password) and transmits it to the host computer. When authentication information is inputted by a user and justified, a printing apparatus starts a print processing on the basis of the print data obtained from the server.

The secure print function as described above is used for preventing an outsider from seeing the content of a printed matter or for ensuring the user to receive the printed matter.

Unfortunately, with each of the known technologies, even when one and the same user creates numerous print jobs (hereinafter “jobs”) and performs print processings on the basis of a common document, different passwords are generated and issued for the jobs based on the common content. Hence, regardless of the common document, the user is required to learn all, or have access thereto, all the different passwords and further be able to individually input them in the printing apparatus. As a result, the known secure print systems are not user-friendly due to the tedious process of having to input in numerous passwords or the like.

### SUMMARY OF THE INVENTION

In view of the above problems, the present invention has been made and is directed to, for example, a technology for achieving easy-to-use secure print. In one aspect of the present invention, a printing apparatus according to the present invention includes a generating unit generating first authentication information corresponding to inputted print data on the basis of predetermined information; a storage unit storing the first authentication information and the print data; an input-accepting unit accepting an input of second authentication information; and a control unit determining, on the basis of the first authentication information, whether the inputted second authentication information corresponds to the first authentication information and, if the inputted second authentication information corresponds to the first authentication information, performing a print processing on the basis of the print data authentication, wherein the predetermined information includes specific information accompanying the print data.

Other features and aspects of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments, features and aspects of the invention and, together with the description, serve to explain the principles of the invention.

FIG. 1 is a block diagram of an exemplary configuration of a printing apparatus according to an embodiment of the present invention.

FIG. 2 is a block diagram of an exemplary configuration of software for use in the printing apparatus.

FIG. 3 shows example print-request packet data received by the printing apparatus.

FIG. 4 shows an example Response packet data transmitted by the printing apparatus.

FIG. 5 is a flowchart of an exemplary operation of the printing apparatus upon receipt of a print request in the case of a normal print processing.

FIG. 6 shows example packet data for transferring print data in the present embodiment.

FIG. 7 shows example receipt-response packet data of the print data in the present embodiment.

FIG. 8 shows example error-response packet data in the present embodiment.

FIG. 9 shows example secure-print response packet data received by the printing apparatus.

FIG. 10 shows example secure-print response packet data transmitted by the printing apparatus.

FIG. 11 shows an example pop-up screen for notifying a password to a user in the present embodiment.

FIG. 12 is a flowchart of an exemplary operation of the printing apparatus upon executing secure print.

FIG. 13 is a flowchart of an exemplary operation of the printing apparatus for generating a password.

FIG. 14 shows an example job list in a first example operation of the printing apparatus displayed after completion of receiving print data intended for performing secure print.

FIG. 15 shows an example screen in the first example operation of the printing apparatus for inputting a password noticed upon executing print.

FIG. 16 is a flowchart of an exemplary operation of the printing apparatus upon executing print in the first example operation.

FIG. 17 shows an example password-inputting screen displayed on an operation panel of the printing apparatus in a second example operation.

FIG. 18 is a flowchart of an exemplary operation of the printing apparatus upon executing print in the second example operation.

FIG. 19 diagrammatically shows an exemplary state in which a print job and its accompanying information are stored in storage.

FIG. 20 is a flowchart of an exemplary processing of a host computer from accepting a print-request to transmitting CreateJob packet data to the printing apparatus.

FIG. 21 shows an example screen for setting a password-generation policy.

FIG. 22 shows an example screen in the second example operation for inputting a password, displayed on the operation panel of the printing apparatus.

### DESCRIPTION OF THE EMBODIMENTS

Embodiments, features and aspects of the present invention will be described with reference to the attached drawings. However, components in the embodiments are described by way of example and not intended to limit the scope of the invention.

Exemplary System Configuration

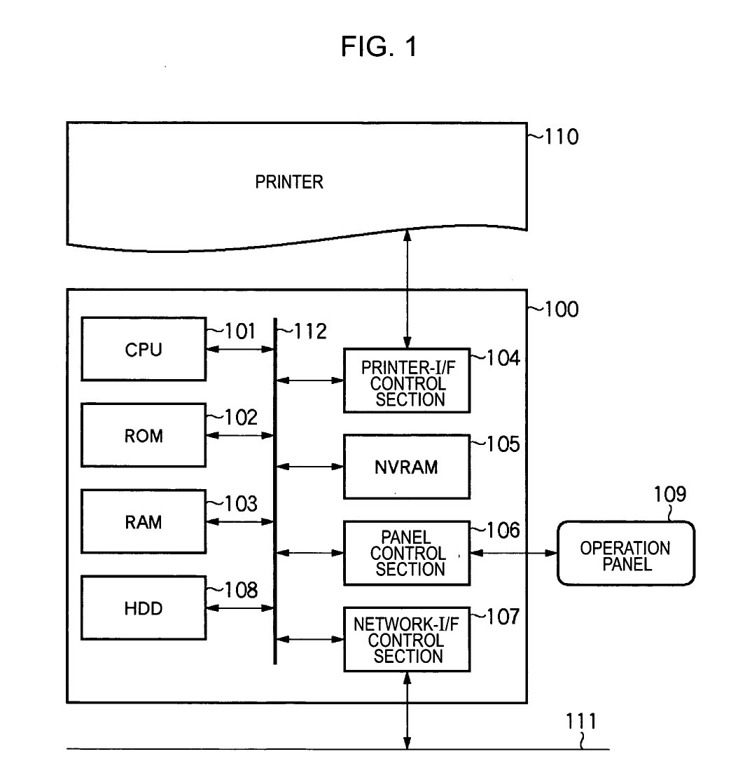

FIG. 1 is a block diagram of the configuration of a printing apparatus 100 according to a first embodiment of the present invention. Upon receipt of print data, the printing apparatus 100 controls a print processing of a printer 110, which will be described later. The printing apparatus 100 includes components 101 through 108, and 112, which will be described later. The printer 110 performs a predetermined print processing in accordance with the control of the printing apparatus 100. An operation panel 109 serving as a user-interface accepts an instruction input of a user and displays a processed result and so forth. The operation panel 109 may include, for example, a touch panel. An exemplary network 111 is configured by a local area network (LAN) in the present embodiment, however, it is noted that the network 111 may also be a wide area network, the Internet or the like.

The component 101 is a central processing unit (CPU). The CPU 101 executes an application program, an operation system (OS), a control program, and the like, stored in a hard disk drive (hereinafter, referred to as an HDD) 108 or other form of memory, which will be described later, and controls the printing apparatus while temporarily storing information, files, and so forth, in a random access memory (RAM) 103, which will be described later, used for executing the programs.

The component 102 is a read-only-memory (ROM). The ROM 102 stores programs such as a boot program, fixed parameters, and a basic I/O program of the apparatus, and a variety of data such as font data and template data used upon document processing. The RAM 103 temporarily stores a variety of data and serves as a main memory, a work area, and the like of a CPU 101.

The component 108 is an external storage. In the present embodiment, an HDD serving as a large capacity memory is utilized as the external storage 108, however, it is acknowledged that other forms or memory may also serve an equivalent function. The HDD 108 stores print data, an application program, an OS program, a control program, related programs and so forth. The component 104 is a printer-interface control section (hereinafter “printer−1/F control section”) configured to control the printer 110 with communication.

The component 105 is a non-volatile random access memory (NVRAM) for storing a variety of setting values and so forth of the printing apparatus. The component 106 is a panel control section controlling the operation panel 109 so as to, for example, display a variety of information and accept an instruction of the user. The component 107 is a network-I/F control section controlling transmit-receipt of data with the LAN 111.

The component 112 is a system bus via which a control signal from the CPU 101 and data signals among the components are transmitted and received. The system bus 112 has the CPU 101, the ROM 102, the RAM 103, the HDD 108, the printer−1/F control section 104, the NVRAM 105, the panel control section 106, and the network-I/F control section 107 connected thereto.

Alternatively, software achieving an equivalent function of each of the components may be replaced with the hardware components.

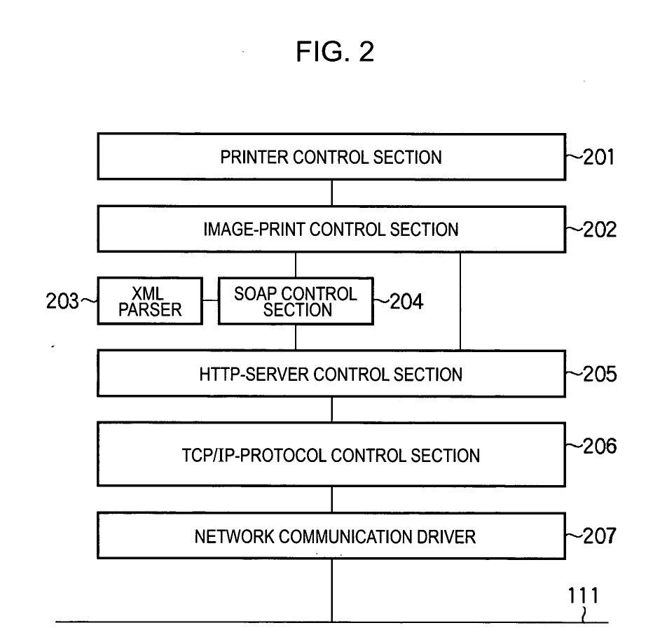

FIG. 2 is a block diagram of the configuration of software for use in the printing apparatus 100 according to the present embodiment. A block 201 is a printer control section serving as a module, configured to control the printer-I/F control section 104. The printer control section 201 processes transmission of image data, a paper-outputting position, and so forth of the printer 110.

A block 202 is an image-print control section configured to convert received print data so as to be printed by the printer 110 and perform a variety of control about printing, for example, the number of copies and double-sided printing. A block 207 is a network communication driver configured to control the network-I/F control section 107 so as to transmit-receive data with the network 111. A block 206 is a TCP/IP protocol control section. The TCP/IP protocol control section 206 includes a module configured to control a TCP/IP protocol and controls transmission-receipt of data in conformity to the TCP/IP protocol with the network communication driver 207.

A block 205 is a hypertext transfer protocol (HTTP) server control section serving as a module configured to control the overall HTTP. The HTTP-server control section 205 analyzes an HTTP request packet received from an external device (a host computer or a client), appropriately processes it, and transfers the processed data to upper applications such as the image-print control section 202 and a simple object access protocol (SOAP) control section 204, which will be described later. In addition, the HTTP-server control section 205 controls an HTTP response packet so as to be returned to the host computer on the basis of an instruction of one of the upper applications.

A block 204 is the above-described SOAP control section serving as a module configured to control a protocol called a SOAP. The SOAP control section 204 analyzes data written in an extensible markup language (XML) format, received from the external device (the host computer or the client), with an XML parser 203 and cells up an appropriate module of the image-print control section 202. Also, the SOAP control section 204 converts data, which is to be returned to the host computer, into XML data and returns it to the host computer via the HTTP-server control section 205. A block 203 is the foregoing XML parser and serves as a module configured to receive data written in the XML format and outputting the analyzed result.

Exemplary Normal Print Processing

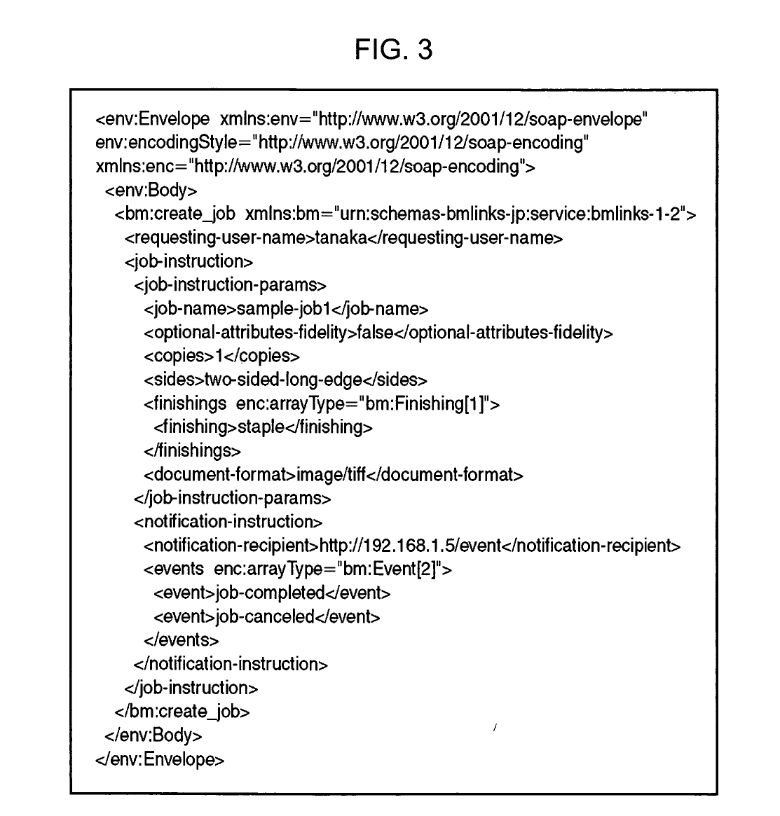

Example packet data transmitted from an external device (a host computer or a client) to the printing apparatus 100 with the SOAP on the HTTP according to the present embodiment will be described. FIG. 3 shows example packet data called a “Create_job”, written in the XML format, and transmitted from the host computer to the printing apparatus 100.

The Create_job packet serves as a command instructing the printing apparatus 100 to start a job (print). The Create_job packet includes information such as a user name of a requesting source (indicated by a <requesting-user-name> tag) and an instruction about processing the job (indicated by a <job-instruction> tag). In the present specification, unless otherwise noted, a job name means a document name of a printing object and does not indicate a unique identification (ID) identifying the job.

The <job-instruction> tag includes a <copies> tag for setting the number of copies, a <sides> tag for setting two-sided print, and a <finishing> tag for setting print finishing. The printing apparatus 100 processes the job on the basis of values set in these tags. Also, the <job-instruction> tag includes a <document-format> tag indicating a data format of the print job. In the example packet data shown in FIG. 3, a value of image/tiff is set in the <document-format> tag, indicating that data of the job is written in a tag image file format (TIFF).

Optionally, the <job-instruction> tag may further include a <notification-instruction> tag. The <notification-instruction> tag sets forth notification information about the job. In the example packet data shown in FIG. 3, a <notification-recipient> tag for setting a notification recipient and an <event> tag for setting notification conditions are written so as to serve as the notification information.

The printing apparatus 100 performs an event-transmission processing on the basis of values set in the foregoing tags. Meanwhile, the descriptive format of the packet data shown here is provided merely by way of example, and the present invention is not limited to this. The same is applied to the descriptive format of packet data, which will be described later.

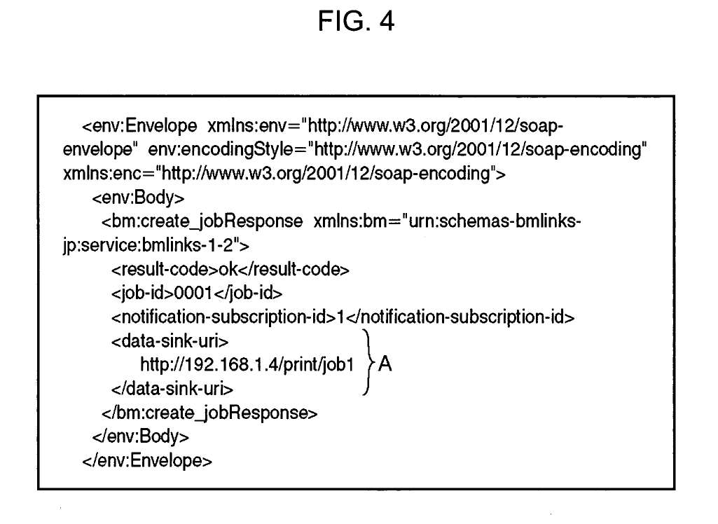

Referring now to FIG. 4, example response packet data in response to the Create_job packet shown in FIG. 3 will be described. The response packet data is also written in the XML format in the same fashion as in the packet data shown in FIG. 3 and, in the present embodiment, is transmitted-received with the SOAP on the HTTP. The Create_job response packet includes information such as a result code responsive to a CreateJob command, a generated job identifier, and a printing-port uniform resource identifier (URI). In FIG. 4, the result code responsive to the CreateJob command is indicated by a <result-code> tag, the job identifier is indicated by a <job-id> tag, and the printing port URI is indicated by a <data-sink-uri> tag. Further, in FIG. 4, the URI is written in a part A of the packet data as “http://192.168.1.4/print/job1”. As will be described later, the host computer transmits predetermined print data to the URI.

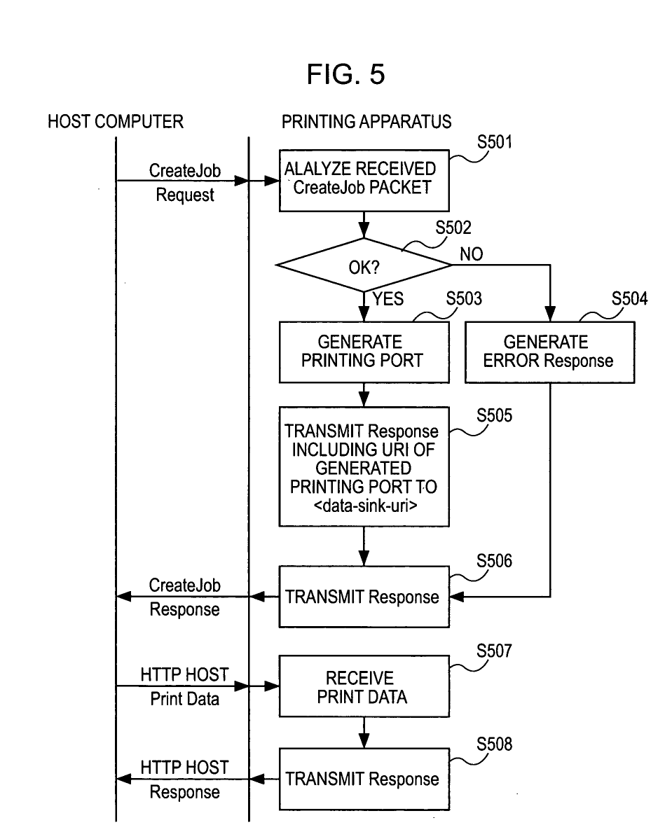

Referring now to FIG. 5, an exemplary operation of the printing apparatus 100 when an external device (a host computer or a client) transmits print data and so forth to the printing apparatus 100 so as to start a print processing will be described. FIG. 5 is a flowchart of the operation of the printing apparatus 100 upon receipt of a print request from the host computer in the case of a normal print processing.

When the Create_job packet, for example, as shown in FIG. 3 is received from the host computer, in step S501, the printing apparatus 100 analyzes XML data written in the Create_job. In step S502, the printing apparatus 100 determines whether the analyzed result includes an error, i.e., whether the analysis is justified. If justified (i.e., no error included, or if YES in step S502), the process proceeds to step S503. If not justified, (if NO in step S502), the process proceeds to step S504.

In step S504, an error response data is generated, and, in step S506, the generated error response data is transmitted to the host computer. FIG. 8 shows an example error response data. With tags such as <faultcode> and <faultstring>, information about an error is notified to the host computer. Upon receipt of the error response data, the host computer ends the process without transmitting the print data.

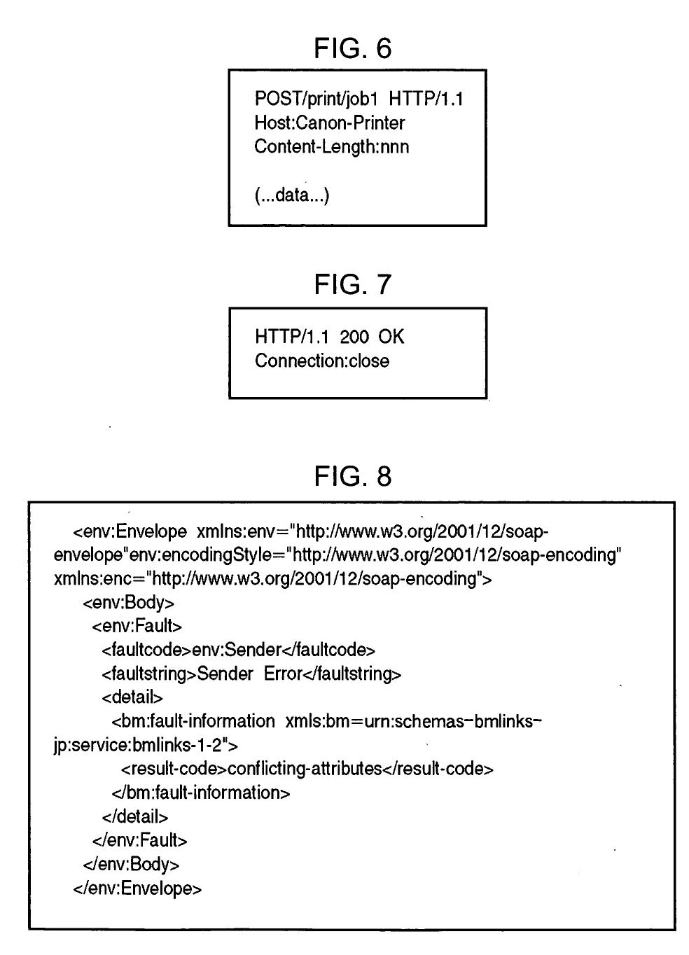

A printing port for receiving the print data is generated in step S503. In step S505, XML data serving as a response (Response) to the Create_job packet is generated. On this occasion, the port URI generated in step S503, for receiving the print data, is set as a value of the <data-sink-uri> tag. For example, the URI shown in FIG. 4 is embedded in the XML data. When generation of the Create_job Response data is completed, in step S506, the Response data is transmitted to the host computer with the SOAP. The host computer then analyzes the received Response data and transmits the print data to the URI specified by the <data-sink-uri> tag with the HTTP POST method. FIG. 6 shows an example packet for transferring the print data with the HTTP POST method.

In step S507, the printing apparatus 100 receives data having already reached the printing port and controls the printer 110 so as to execute the print processing while performing an appropriate processing. Here, it is presumed that the print data is written in the TIFF as shown in FIG. 3. In this case, the data transmitted in the TIFF is compressed, e.g., with the modified Huffman encoding method if the data is intended for monochrome print and with the Joint Photographic Experts Group (JPEG) encoding method if the data is intended for color print.

When receipt of the print data is normally completed in step S507, the printing apparatus 100 transmits an example HTTP response packet shown in FIG. 7 to the host computer in step S508, eliminates (closes) the printing port, and ends the printing operation.

Exemplary Operation for Secure Print

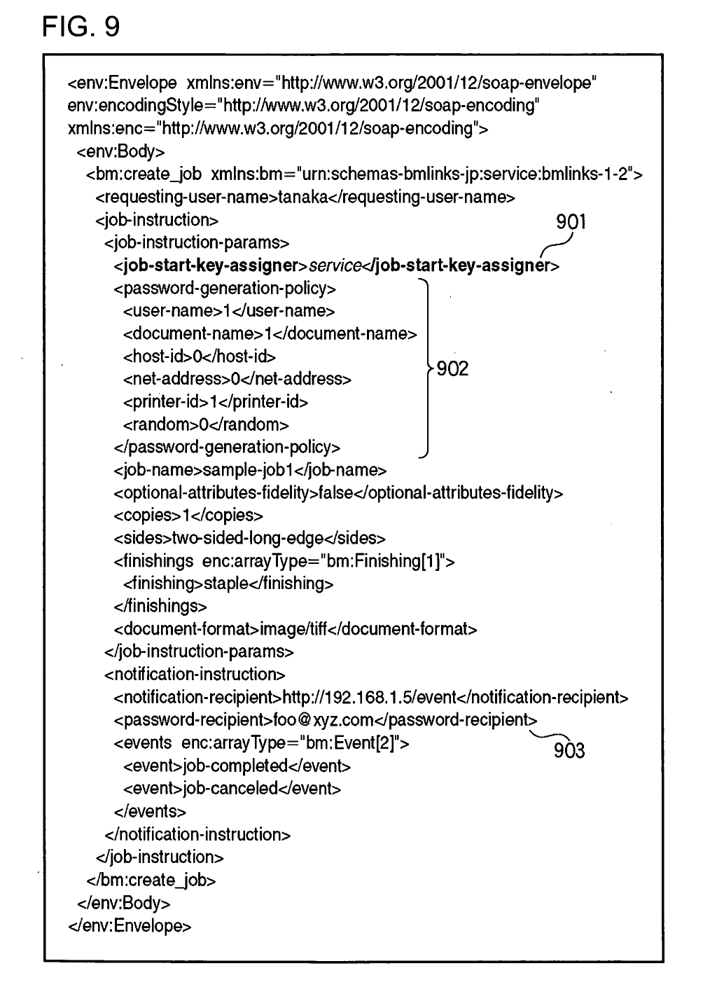

Exemplary packet data of a Create-job serving as a print-start request for performing secure print will now be described. FIG. 9 shows example packet data of the Create-job serving as a print-start request for performing secure print. The secure print is defined as a printing method requiring authentication information such as a password to be input prior to performing secure print.

Different from the packet data shown in FIG. 3, the packet data shown in FIG. 9 includes a <job-start-key-assigner> tag 901. When assigned in the Create-job packet, the <job-start-key-assigner> tag 901 indicates that the present print is secure print. The <job-start-key-assigner> tag 901 has a value of “service” in FIG. 9, indicating that the printing apparatus 100 issues a password.

As shown in FIG. 9, the packet data has a part 902 describing a policy (a password generation policy) at the time when the printing apparatus 100 generates a password. As will be described in detail later, the present embodiment has a feature in generating a password on the basis of specific information accompanying print data, information specific to the printing apparatus, or the like. The part 902 describes that the printing apparatus 100 generates a password on the basis of what specific information, wherein values of “1” and “0” respectively indicate that the corresponding information is used and not used for password generation. In the part 902, <user name>, <document name>, and <host-id> indicate a user name, a document name, and a host computer ID, respectively. Also, <net-address>, <printer-id>, and <random> respectively indicate a network address, a printing apparatus ID, and a random flag.

In addition, a <password-recipient> tag 903 shown in FIG. 9 assigns an apparatus to which the printing apparatus 100 notifies the password. FIG. 9 shows an example case where the printing apparatus 100 requests a mail address assigned as “foo@xyz.com” to which the password is notified by E-mail.

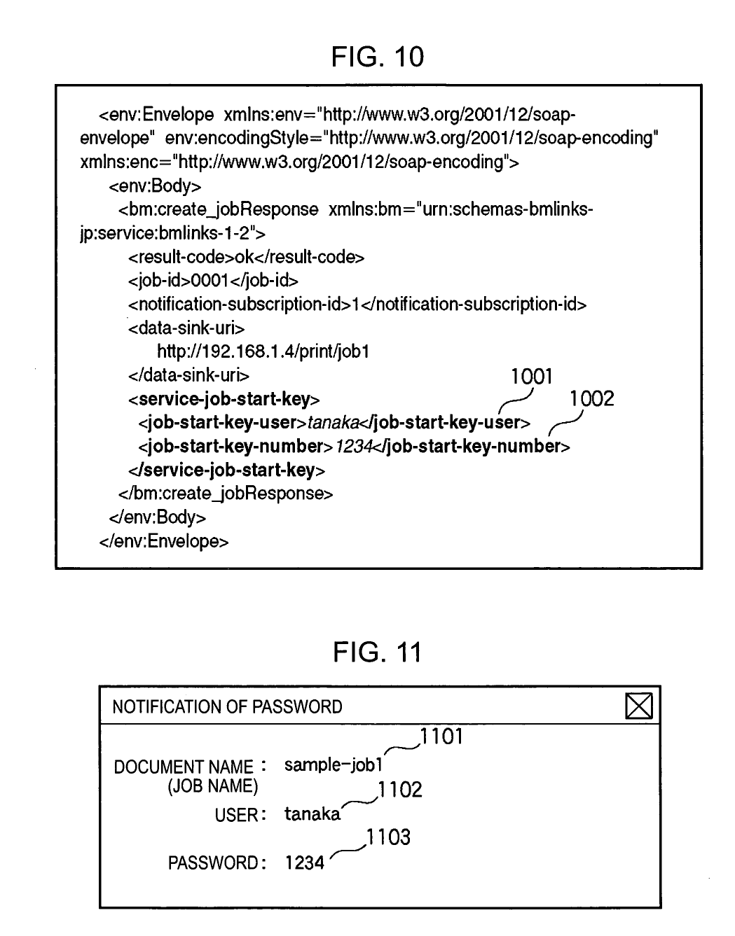

Upon receiving a packet of the Create-job serving as a print start request for performing secure print, the printing apparatus 100 transmits packet data in response to the request. The packet data will now be described in more detail. FIG. 10 shows example packet data when the printing apparatus 100 having received the Create-job packet shown in FIG. 9 returns the corresponding response to the host computer.

Different from the packet data shown in FIG. 4, the packet data shown in FIG. 10 has a <server-job-start-key> tag including a tag 1001 attribute to <job-start-key-user> and a tag 1002 attribute to <job-start-key-number>. The tag 1001 attribute to <job-start-key-user> indicates a user name of a requesting source and refers to a value of “tanaka” attribute to <requesting-user-name> included in the Create-job without modification. The tag 1002 attribute to <job-start-key-number> indicates a password generated by the printing apparatus 100 for the job and accompanying the job.

Upon receipt of the response packet as shown in FIG. 10, the host computer outputs and displays a pop-up screen as shown in FIG. 11 and notifies a password and so forth to a user. In FIG. 11, reference numbers 1101, 1102, and 1103 respectively indicate a document name, a user name, and a password. The document name 1101 corresponds to a job name and controls data stored in the host computer so as to be displayed. In the meantime, it is presumed that the printing apparatus 100 understands the relationship between a CreateJob packet and print data with a session identification number or the like in a lower layer. In FIG. 11, a password notified by the tag 1002 attribute to <job-start-key-number> is displayed. The password 1103 is issued for the print job. At the start of printing, a user inputs this password on the operation panel 109 of the printing apparatus 100.

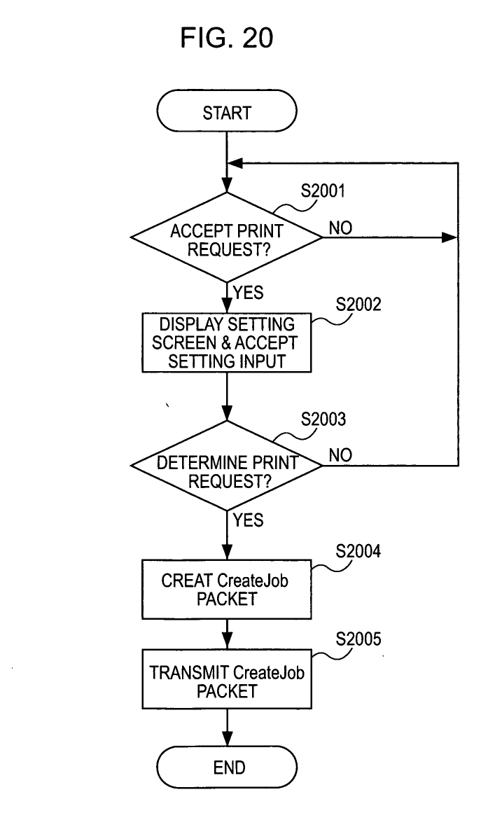

Referring now to FIG. 20, an exemplary processing of the host computer from creation of a print job for requesting secure print to its transmission to the printing apparatus 100 will be described. FIG. 20 is a flowchart of a processing of the host computer from acceptance of the print-request to transmission of a CreateJob packet to the printing apparatus.

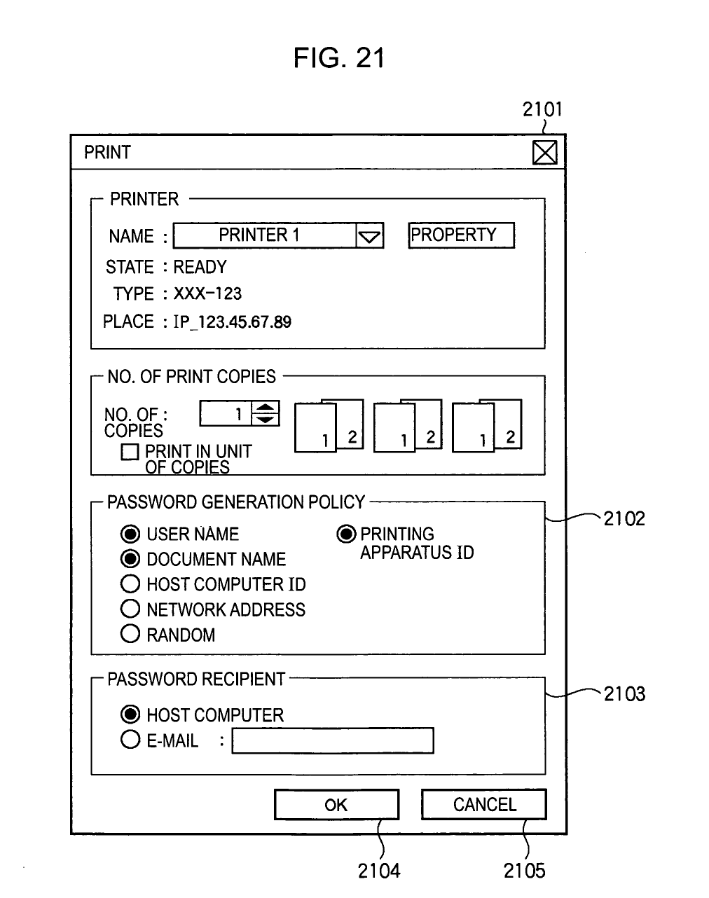

It is determined in step S2001 whether the host computer accepts a print request via an upper application such as document-creating software. If YES, the process moves to step S2002. In step S2002, the host computer displays an example setting screen 2101 on a predetermined display screen as shown in FIG. 21 and controls it such that printing conditions including the number of copies and the name of a printer can be specified and information such as a password generation policy can be set.

As shown in FIG. 20, an exemplary setting screen 2101 is displayed to the user. The setting screen 2101 includes a screen 2102 for setting a password generation policy. FIG. 21 shows an example case where elements for achieving password generation can be selected with respective check boxes. When the user selects the check boxes as shown by the screen 2102 and transmits a print request, the printing apparatus 100 generates a password on the basis of respective pieces of information: a user name, a document name, and a printing apparatus ID. A check box RANDOM in the screen 2102 indicates that a password is randomly generated on the basis of respective pieces of information: e.g., a user name, a document name, and so forth. A check box PRINTING APPARATUS ID indicates information specific to an individual printing apparatus. When the check box PRINTING APPARATUS ID is selected as an element for password generation upon performing secure print of print data with one and the same document name or the like, passwords can be made different from one printing apparatus serving as a recipient to another. It is presumed that, in the case of default, the check boxes USER NAME, DOCUMENT NAME, and PRINTING APPARATUS ID are selected as shown in FIG. 21.

Elements for achieving password generation are not limited to those shown in the FIG. 21. Each element may be configured by any information such as a data size of a document, a serial number of the printing apparatus, the name of the printing apparatus, a network address, or a media control address (MAC), as long as these pieces of information are specific information accompanying the print data or the printing apparatus.

The setting screen 2101 also includes a screen 2103 showing that the printing apparatus 100 is designated as a notification recipient of the generated password. According to the present embodiment, by designating notification recipients of the password, a user can designate desired recipients (e.g., a computer in the field and a portable phone) other than the host computer.

Upon setting a printer, a printing method, and the number of copies in addition to the above-described items, the user determines the print request by selecting an OK button 2104. The user can cancel the print request by selecting a CANCEL button 2105. If the OK button 2104 is selected (if YES in step S2003), the operation of the host computer moves to step S2004. If the CANCEL button 2105 is selected (if NO in step S2003), the operation returns to step S2001.

In step S2004, the example CreateJob packet, for example, as shown in FIG. 9 is created on the basis of the respective pieces of information set on the setting screen 2101. The packet is transmitted to the printing apparatus 100 in step S2005. As described above, <user name>, <document name>, and <host-id> in the part 902 shown in FIG. 9 respectively indicate a user name, a document name, and a host computer ID. Also, <net-address>, <printer-id>, and <random> respectively indicate a network address, a printing apparatus ID, and a random flag. In addition, values of “1” and “0” respectively indicate that the corresponding information is used and not used for password generation. In the example packet data in FIG. 9, a user name, a document name, and a printing apparatus ID are selected for password generation.

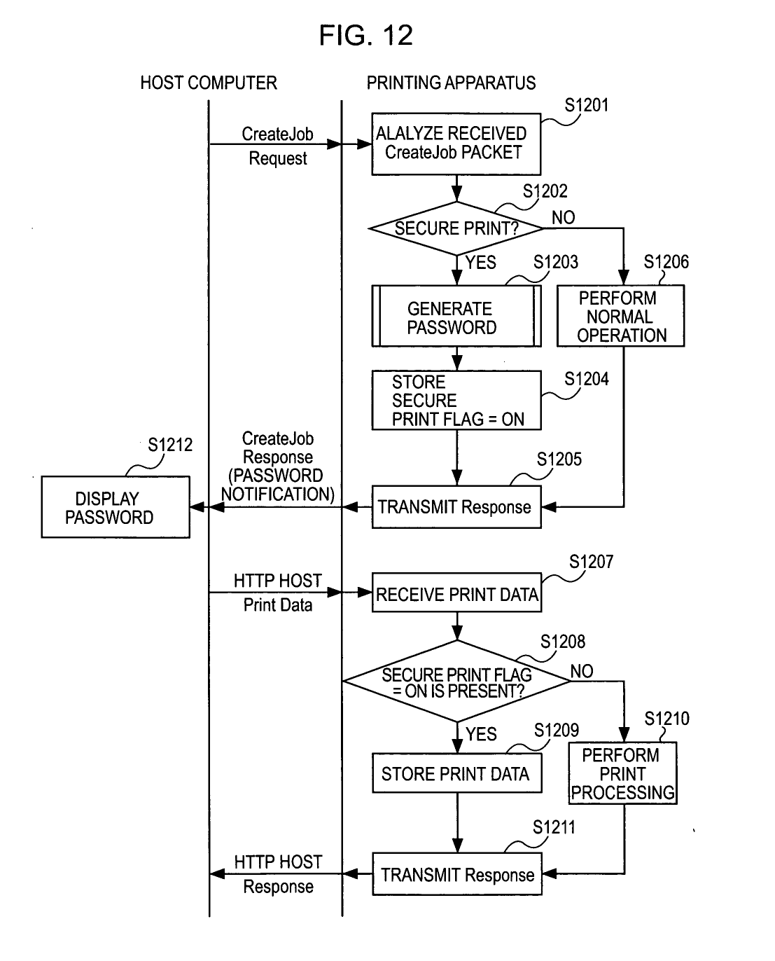

Referring now to FIG. 12, an operation of the printing apparatus 100 when the host computer transmits print data and the like to the printing apparatus 100 for initiating a print processing of secure print will be described. FIG. 12 is a flowchart of an exemplary operation of the printing apparatus 100 upon receiving a print request from the host computer for performing the secure print. In the following description, it is presumed by way of example that the host computer is selected as a password recipient in step S2002 shown in FIG. 20.

Upon receipt of the Create-job packet, for example, as shown in FIG. 9, the printing apparatus 100 analyzes the received Create-job packet in step S1201, and the process then proceeds to step S1202. On the basis of the analyzed result in step S1201, the printing apparatus 100 determines in step S1202 whether the received Create-job packet requests secure print. More particularly, when the Create-job packet includes a <job-start-key-assigner> tag and the tag has a value of “service”, the printing apparatus 100 determines that the secure print is requested. If the determination is a request of the secure print (if YES in step S1202), the process proceeds to step S1203. Otherwise (if NO in step S1202), the process proceeds to step S1206.

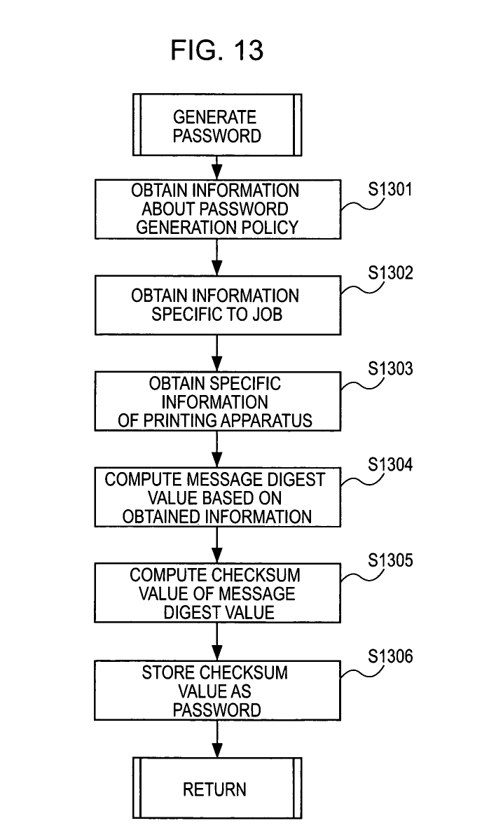

In step S1203, the printing apparatus 100 generates a password according to its operation shown in FIG. 13 for password generation, which will be described later, and temporally stores it in storages such as the RAM 103 and the HDD 108. In step S1204, the printing apparatus 100 keeps areas in the storages such as the RAM 103 and the HDD 108 and temporally stores a secure print flag having a value of ON in the areas. In the following step S1205, the printing apparatus 100 creates the response (Response) packet as shown in FIG. 10, including the password generated in the step S1203 and transmits the packet to the host computer. When an E-mail address is inputted as a password recipient in step S2002, the printing apparatus 100 transmits an E-mail including the password to the E-mail address.

On the other hand, if the determination is not a request of the secure print (if NO in step S1202), the printing apparatus 100 performs its normal processing of steps S503 and S505 shown in FIG. 5. With this, the normal Response packet as shown in FIG. 4 is created and transmitted to the host computer in step S1205.

The printing apparatus 100 waits for a response from the host computer after transmission of the Response packet in step S1205. Upon receipt of the Response packet including the password, in step S1212, the host computer displays a screen as shown in FIG. 11 so as to notify the password and so forth to the user and transmits the print data in a format, for example, as shown in FIG. 6 to the printing apparatus 100.

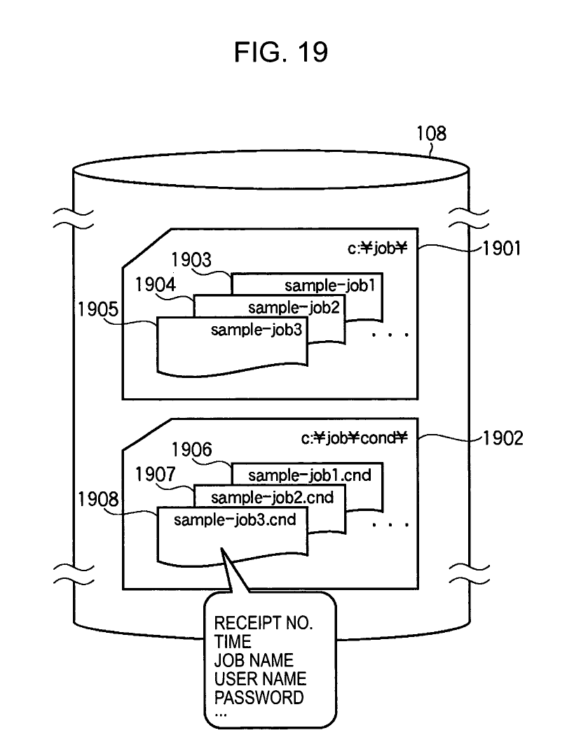

When the print data is transmitted from the same host computer as described above, the printing apparatus 100 receives the data in step S1207 and determines in step S1208 whether a secure print flag having a value of “ON” is present in the storages. If present (in YES in step S1208), the printing apparatus 100 determines that the flag indicates secure print, and the process proceeds to step S1209. In step S1209, the printing apparatus 100 stores the print data received as shown in FIG. 19 in a job storage area 1901 of each of the storages such as the HDD 108 and information (such as a receipt number, a time, a job name, a user name, a password, and an address of the print data) accompanying the job in a accompanying-information storage area 1902 of each of the storages. Then, the process proceeds to step S1211 where when the printing apparatus 100 transmits the Response packet to the host computer in step S1211, the process ends.

If absent (if NO in step S1208), the printing apparatus 100 determines that the flag indicates normal print, and the process proceeds to step S1210. In step S1210, on the basis of the received print data, the printing apparatus 100 controls the printer 110 so as to perform a print processing. Then, the process proceeds to step S1211. When the printing apparatus 100 transmits the Response packet to the host computer in step S1211, the process ends.

Referring now to FIG. 13, the password-generation processing conducted in step S1203 shown in FIG. 12 will be described in more detail. In step S1301, information about the password generation policy noticed from the host computer is obtained. In an example according to the present embodiment, the part 902 of the packet data shown in FIG. 9 is analyzed so as to obtain the policy information.

In step S1302, information specific to the job is obtained from the data of the Create-job packet. In the present embodiment, values of tags respectively attribute to <requesting-user-name> (a user name) and <job-name> (a document name) are obtained on the basis of the assignments stated in the part 902 of the packet data shown in FIG. 9. In the example case shown in FIG. 9, these values correspond to “tanaka” and “sample-job1”, respectively. When other pieces of information are selected, the pieces of information are obtained.

In step S1303, information specific to the printing apparatus 100 is obtained. In the present embodiment, a manufacturer's serial number of the printing apparatus 100 is obtained on the basis of assignments of the part 902 of the packet data. When an MAC address or the like of a network interface is assigned, its value is obtained. When the user does not select a password generation policy, step S1303 is omitted.

In step S1304, a message digest value is computed on the basis of the respective pieces of information obtained in steps S1302 and S1303. The message digest value (hash value) may be computed by any one of the known methods such as the message digest number 4 (MD4), the message digest number 5 (MD5), and the secure hash algorithm 1 (SHA-1). The message digest value outputted after computation is expressed in a 128-bit length (16 bites) with the MD4 or MD5 and in a 160-bit length (20 bites) with the SHA-1.

In step S1305, a checksum value of the message digest value computed in step S1304 is computed. While a variety of checksum computing methods are available, any one of known methods is used. For example, a method for computing a checksum value of an IP header in the TCP/IP protocol may be used. Here, the checksum value of the IP header is computed in the following procedure: (1) data is divided every 16 bits and 1's complement sum of all 16 bits is computed; and (2) 1's complement of the computed 1's complement sum is set as the checksum value, wherein the outputted checksum value is expressed in 2 bites.

It is also possible that processing step S1305 is eliminated and the message digest value computed in step S1304 is used as a password without modification. In this case, by converting the message digest value computed, for example, with the MD5 and expressed in 16 bites into a character string, a 32-character password is obtained. With this method, while a probability of password duplication is low on one hand, a user must remember and input a 32-character password on the other. As oppose to this, by processing step S1305, a 4-character password is generated on the basis of information specific to a job or a printing apparatus.

In step S1306, the 2-bite value computed in step S1305 is interpreted as a 4-character string and the character string is stored as a password.

As described above, with the configuration of the printing apparatus according to the present embodiment, a user can simply control generation of a password for its application purpose. In an example case of issuing a large amount of print requests of a common document to a common printing apparatus, the user sets the setting screen 2101 so as to generate a password on the basis of a user name, a document name, and a printing apparatus ID as shown in FIG. 21. With this arrangement, a common password is issued for all print jobs, thereby allowing the user to execute secure print only by remembering a single password.

In another example case of printing a large amount of mutually different documents with a common host computer, a user designates the user name check box and the host computer ID check box so as to generate a password. With this arrangement, a common password is issued for all print jobs requested by the single user with one and the same host computer, thereby allowing the user to execute secure print with a single password.

In another example case of printing a large amount of mutually different documents with a plurality of host computers, a user designates only the user name check box so as to generate a password. With this arrangement, even when the single user issues a print request with a variety of host computers, the user can execute secure print with the common password.

In another example case of placing great importance on confidentiality of a document, a user selects the random check box. With this arrangement, passwords different for respective print jobs are issued, allowing the user to execute safe secure print.

While elements constituting the password generation policy and a method for selecting the elements are not limited to those described in the present specification, these elements are configured depending on the application and purpose of secure print.

The operation of the printing apparatus 100 from transmission of a print request from the host computer to the printing apparatus 100 to completion of receiving print data by the printing apparatus 100 has been described above. Subsequently, an operation of the printing apparatus 100 after completion of receiving the print data will be described while quoting two examples.

Exemplary Operation After Completion of Receiving Print

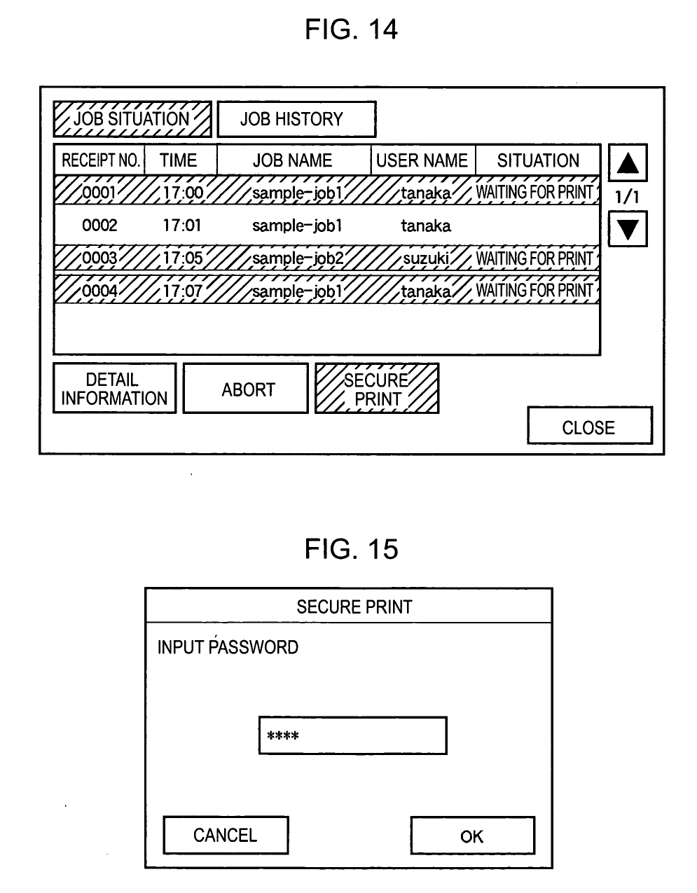

In a state in which print jobs designating secure print are introduced in the printing apparatus 100, while referring to the accompanying-information storage area 1902 on the basis of a predetermined inputs, the printing apparatus 100 displays a list of the introduced print jobs on the operation panel 109. FIG. 14 shows an example state of the operation panel 109 on which the job list is displayed after the printing apparatus 100 completes receipt of print data intended for secure print.

As shown in FIG. 14, when information such as a receipt number, a time, a job name, a job-introducing user name, and a printing situation is displayed for each of the introduced jobs, a user can easily select a desired print job. By configuring the operation panel 109, for example, with a touch panel, the user can select the desired job by pressing an area of the touch panel, displaying the desired job.

FIG. 14 illustrates a situation in which print jobs shown by receipt numbers 0001, 0002, and 0004 are selected by a user. It is presumed here that the selected jobs indicate one and the same job “sample-job1” requested by the single user “tanaka” and that the print requests are directed to the common printing apparatus 100. In addition, it is presumed that the password generation policy is set for a default, that is, so as to generate a password on the basis of a user name, a document name, and a printing apparatus ID. In this case, with the above-described password-generation processing, the passwords generated for these jobs are identical to one another. Hence, when a SECURE PRINT button is pressed by the user under such a situation, the printing apparatus 100 displays a password-inputting screen as shown in FIG. 15, common to the print jobs shown by the receipt numbers 0001, 0002, and 0004.

FIG. 15 shows an example screen in the first example operation of the printing apparatus, for inputting a password noticed upon executing print. When the user inputs a proper password and presses an OK button on this screen, the printing apparatus 100 controls the printer 110 so as to execute a print processing on the basis of the specified print job.

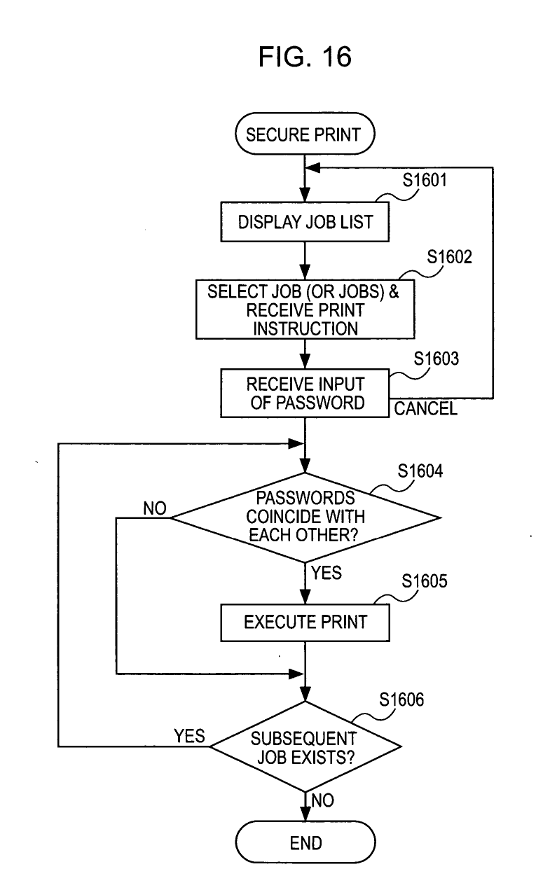

The above-described print processing will now be described in more detail with reference to FIG. 16 which is a flowchart of an exemplary operation of the printing apparatus upon executing print in the first example operation. In step S1601, while referring to the accompanying-information storage area 1902, the printing apparatus 100 controls the operation panel 109 so as to display the example job list as shown in FIG. 14 such that desired print jobs can be selected by the user. When a plurality of the print jobs is selected and the “SECURE PRINT” button is pressed by the user in step S1602, the process proceeds to step S1603.

In step S1603, the password-inputting screen as shown in FIG. 15 by way of example is displayed, and an input of a password by the user is accepted. When the OK button shown in the lower right part of FIG. 15 is pressed after the predetermined input, the process proceeds to step S1604. When the CANCEL button shown in the lower left part of the same figure is pressed, the process returns to step S1601.

While referring to the accompanying-information storage area 1902, the printing apparatus 100 determines in step S1604 whether the inputted value coincides with a password stored in association with the first one of the selected jobs (the job specified by the receipt number 0001 in the example list shown in FIG. 14). Since password generation in this example is performed with default setting, when the selected jobs are related to the common user and the common document, the passwords stored in association with these jobs are identical to one another.

When the passwords coincide with each other (if YES in step S1604), the process proceeds to step S1605, and secure print is executed on the basis of the first job (the job specified by the receipt number 0001 in the example list shown in FIG. 14). Upon completion of the secure print, the process proceeds to step S1606. When the passwords do not coincide with each other (if NO in step S1604), the process proceeds to step S1606 without any processing.

The printing apparatus 100 determines in step S1606 whether the subsequent job exists, in other words, whether, of the print jobs selected by the user, some having passwords already evaluated exist. In the example shown in FIG. 14, passwords corresponding to the print jobs specified by the receipt numbers 0002 and 0004 are not evaluated at this moment. Accordingly, the determination is existence of the subsequent job (YES in step S1606), and the process returns to step S1604. Then, the printing apparatus 100 determines in step S1604 whether the value inputted by the user coincides with a password stored in association with the subsequent job (in FIG. 14, the job specified by the receipt number 0002).

The printing apparatus 100 repeatedly executes steps S1604 through S1606 as described above and controls execution of the print processing on the basis of all print jobs whose authentication is justified. The printing apparatus 100 does not execute and skips the print processing of the remaining print jobs whose authentication is not justified. Hence, in order to execute the print processing of such print jobs, the printing apparatus 100 is required to perform processings again from steps S1601 through S1605.

In the first example operation, it is possible that, as a pre-processing of step S1601, a screen allowing only a user name to be inputted thereon is displayed on the operation panel 109, that print jobs corresponding to the inputted user name are searched for while the accompanying-information storage area 1902 being referred to, and that a list of the searched print jobs is displayed in step S1601.

As described above, according to the present embodiment, by generating a password on the basis of information specific to each of jobs, printing apparatus, or the like, the same jobs transmitted to the common printing apparatus 100 by a single user have a common password issued thereto. This arrangement allows the user to easily manage the password.

Also, the printing apparatus 100 is configured such that a plurality of print jobs can be selected and the corresponding passwords can be repeatedly evaluated, thereby allowing a user to execute a plurality of pieces of secure print with an easy operation.

Second Exemplary Operation After Completion of Receiving Print

In the first example operation, a plurality of jobs is selected upon executing secure print, and all selected jobs are printed by inputting a single password. In a second example operation, when a user name and a password are inputted, the printing apparatus 100 searches for print jobs corresponding to the inputted user name and password and executes a print processing on the basis of the searched jobs.

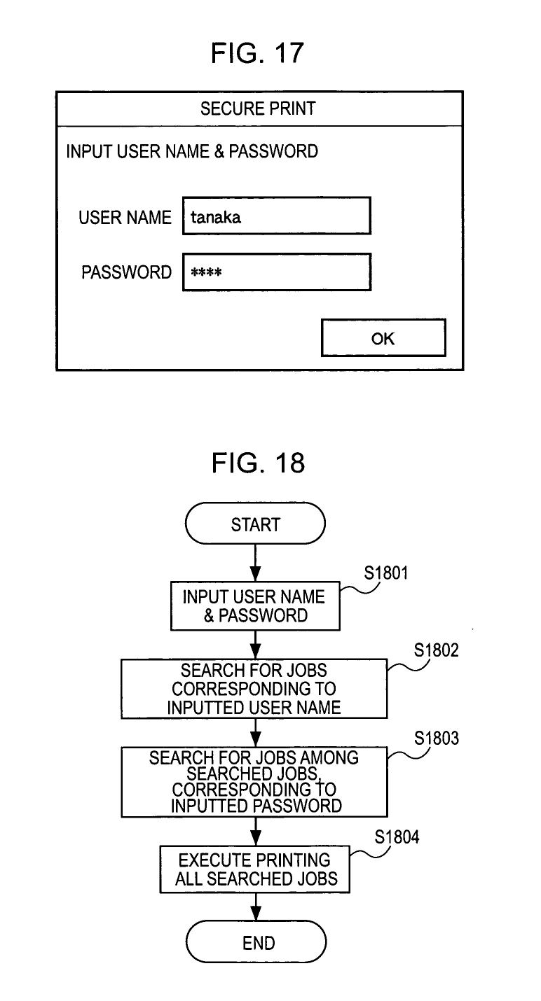

In a state in which a print job designating secure print is introduced in the printing apparatus 100, the printing apparatus 100 displays a screen allowing a user to input a user name and a password on the operation panel 109 on the basis of predetermined inputs. FIG. 17 shows an example password-inputting screen that the printing apparatus 100 displays on the operation panel 109.

The example screen shown in FIG. 17 has two fields displayed thereon, allowing a user name and a password to be respectively inputted therein. The user inputs predetermined character strings in the respective fields with an instruction-inputting device or the like (not shown). When the OK button is pressed after the predetermined character strings are inputted in the respective fields, the printing apparatus 100 searches for jobs corresponding to the inputted user name and password while referring to the accompanying-information storage area 1902 and displays a list of the searched jobs on the operation panel 109. This process will be described with reference to FIG. 18.

FIG. 18 is a flowchart of an exemplary operation of the printing apparatus upon executing secure print in the second exemplary operation. In step S1801, the example screen shown in FIG. 17 is displayed on the operation panel 109 of the printing apparatus 100 so as to prompt the user to input a user name and a password. When the predetermined character strings (the user name and the password) are inputted and the OK button is pressed by the user, the process proceeds to step S1802.

In step S1802, while referring to the accompanying-information storage area 1902, the printing apparatus 100 searches for jobs among the received ones, corresponding to the inputted user name. In step S1803, the printing apparatus 100 searches for jobs among those searched in step S1802, corresponding to the inputted password. In step S1804, the printing apparatus 100 controls the printer 110 so as to sequentially print the jobs searched in step S1803.

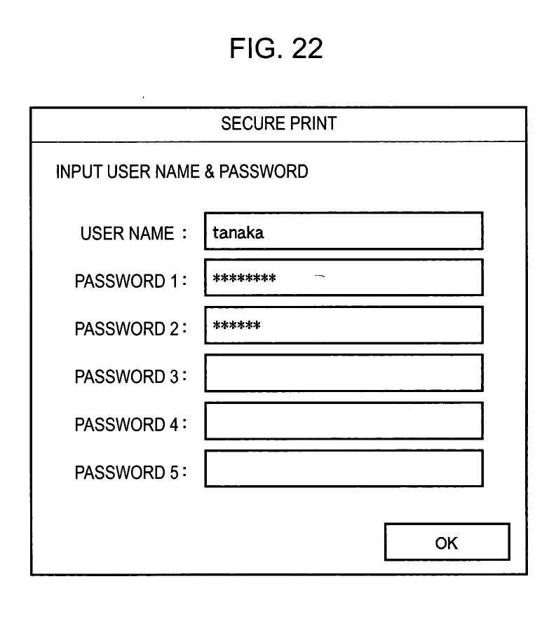

In the second exemplary operation, instead of the input screen shown in FIG. 17, an exemplary input screen as shown in FIG. 22 may be displayed so that a plurality of passwords can be inputted all at once. In other words, jobs corresponding to an inputted user name and each of the inputted passwords may be searched in step S1803. Here, FIG. 22 corresponds to the case where a plurality of passwords is set on the basis of setting the password generation policy.

In the second example operation, in step S1804, a screen for checking a list of print jobs may be displayed so that the searched print jobs are printed after checking of the jobs by the user. In step S1804, a list of the print jobs searched in step S1803 may be displayed so as to prompt the user to select desired print jobs and the selected print jobs to be printed.

Information allowed to be inputted in step S1801 is not limited to a user name and a password. For example, the printing apparatus 100 may be configured such that predetermined conditions such as a part of a file name and a job introduction time can be inputted, and, in step S1804, jobs satisfying all predetermined conditions are searched for and a list of the searched jobs is displayed.

As described above, print jobs are automatically searched for on the basis of an inputted user name and password and the searched jobs are sequentially printed, thereby reducing a troublesome inputting work of a user.

### Other Exemplary Embodiments

While the various exemplary embodiments of the present invention have been described in detail, the present invention can be embodied in forms of, for example, a system, an apparatus, a method, and a program or a recording medium. In concrete terms, the present invention can be applied to a system including a plurality of pieces of equipment or an apparatus including a single piece of equipment.

The present invention also includes the case where a program achieving the function of the foregoing embodiment is supplied to a system or an apparatus directly or from a remote place and the function is achieved by reading and executing a program code of the supplied program with a computer of the system or the apparatus.

Accordingly, the program code installed in the computer so as to allow the computer to achieve the function of the foregoing embodiment is included in the scope of the spirit of the present invention. In other words, a computer program for achieving the function of the foregoing embodiment serves as another embodiment of the present invention. In this case, the program code may be supplied in any form of an object code, a program executable with an interpreter, script data supplied to an operating system, or the like as long as it functions as a program.

As a recording medium for supplying the program, for example, one of the following devices can be a candidate: a floppy disk, a hard disk, an optical disk, a magnetic optical disk, an MO, a CD-ROM, a CD-R, a CD-RW, a magnetic tape, an nonvolatile memory card, a ROM, a DVD (a DVD-ROM, a DVD-R) or the like.

Other than the foregoing recording media, the program can be supplied to the computer such that the computer is connected to Internet via its browser and the computer program according to the present embodiment is downloaded to a recording medium such as a hard disk. Alternatively, the program can be supplied to the computer such that a program code constituting the program according to the present embodiment is divided into a plurality of files and the files are downloaded via respectively different home pages. That is, the present invention includes a World Wide Wed (WWW) server allowing a plurality of users to download the program files for achieving the function of the foregoing embodiment serves as another embodiment of.

Alternatively, the function of the foregoing embodiment can be achieved such that the computer program according to the present embodiment is encrypted, stored in a recording medium such as a CD-ROM, and distributed to users and that some of the users satisfying predetermined conditions are permitted to download decrypting key information from a home page via Internet, to execute the encrypted program with the key information, and install it in the corresponding computers. Further alternatively, the function of the foregoing embodiment can be achieved such that an operating system or the like running on the computer performs a part of or all of an actual process.

Further alternatively, the function of the foregoing embodiment can be achieved such that the program read from a recording medium is written in an extended card inserted in the computer or an extended unit connected to the same and a CPU or the like included in the extended card or the extended unit then performs a part of or all of an actual process.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-340810 filed Nov. 25, 2004, which is hereby incorporated by reference herein in its entirety.

What is claimed is:

1. A printing apparatus, comprising:
a generating unit adapted to generate first authentication information corresponding to inputted print data on the basis of predetermined information;
a storage unit adapted to store the first authentication information and the print data;
an input-accepting unit adapted to accept an input of second authentication information; and
a control unit adapted to determine, on the basis of the first authentication information, whether the inputted second authentication information corresponds to the first authentication information and, if the inputted second authentication information corresponds to the first authentication information, perform a print processing on the basis of the print data authentication,
wherein the predetermined information includes specific information accompanying the print data.

2. The printing apparatus according to claim 1, wherein the specific information accompanying the print data includes information about at least one of a document name, a user name, a data size, a network address, and a media control (MAC) address.

3. The printing apparatus according to claim 1, wherein the predetermined information further includes information specific to the printing apparatus.

4. The printing apparatus according to claim 3, wherein the information specific to the printing apparatus includes information about at least one of a serial number, a printing-apparatus name, a network address, and an MAC address.

5. The printing apparatus according to claim 1, further comprising a setting-accepting unit adapted to accept setting of the predetermined information for use in generating the first authentication information,
wherein the generating unit generates the first authentication information on the basis of predetermined information whose setting is accepted by the setting-accepting unit.

6. The printing apparatus according to claim 1, wherein the generating unit generates the authentication information on the basis of a hash value of the predetermined information.

7. The printing apparatus according to claim 1, wherein the input-accepting unit is further adapted to accept an input of a user name and
wherein the control unit determines, with respect to each piece of the first authentication information associated with the print data corresponding to the user name, whether the inputted second authentication information corresponds to the first authentication information and, if the inputted second authentication information corresponds to the first authentication information, performs a print processing on the basis of the print data.

8. The printing apparatus according to claim 1, further comprising a displaying unit adapted to display a list of the print data stored in the storage unit such that desired print data can be selected,
wherein the input-accepting unit accepts an input of second authentication information corresponding to the selected print data, and
wherein the controlling unit determines, with respect to each piece of the first authentication information associated with the selected print data, whether the inputted second authentication information corresponds to the first authentication information and, if the inputted second authentication information corresponds to the first authentication information, performs a print processing on the basis of the print data.

9. The printing apparatus according to claim 8, further comprising a condition-input accepting unit adapted to accept an input of a predetermined condition,
wherein the displaying unit displays a list of information about the print data satisfying the predetermined condition accepted by the condition-input accepting unit.

10. The printing apparatus according to claim 9, wherein the predetermined condition includes at least one of a user name, authentication information, and a print data name.

11. A printing-apparatus control method, comprising:
generating first authentication information corresponding to inputted print data on the basis of predetermined information;
storing the first authentication information and the print data in a holding unit;
accepting an input of second authentication information; and
controlling a print processing such that a determination is made, on the basis of the first authentication information, whether the inputted second authentication information corresponds to the first authentication information and, if the inputted second authentication information corresponds to the first authentication information, the print processing is performed on the basis of the print data authentication,
wherein the predetermined information includes specific information accompanying the print data.

12. The printing-apparatus control method according to claim 11, wherein the specific information accompanying the print data includes information about at least one of a document name, a user name, a data size, a network address, and an MAC address.

13. The printing-apparatus control method according to claim 11, wherein the predetermined information further includes information specific to the printing apparatus.

14. The printing-apparatus control method according to claim 13, wherein the information specific to the printing apparatus includes information about at least one of a serial number, a printing-apparatus name, a network address, and an MAC address.

15. The printing-apparatus control method according to claim 11, further comprising accepting setting of the predetermined information for use in generation of the first authentication information,
wherein the first authentication information is generated on the basis of the predetermined information whose setting is accepted.

16. The printing-apparatus control method according to claim 11, wherein the authentication information is generated on the basis of a hash value of the predetermined information.

17. The printing-apparatus control method according to claim 11, wherein an input of a user name is further accepted in the input-accepting step and
wherein, in the controlling step, a determination is made, with respect to each piece of the first authentication information associated with the print data corresponding to the user name, whether the inputted second authentication information corresponds to the first authentication information and, if the inputted second authentication information corresponds to the first authentication information, a print processing is performed on the basis of the print data.

18. The printing-apparatus control method according to claim 11, further comprising displaying a list of the print data stored in the storage unit such that desired print data can be selected,
wherein, in the input-accepting step, an input of second authentication information corresponding to the selected print data is accepted, and
wherein, in the controlling step, a determination is made, with respect to each piece of the first authentication information associated with the selected print data, whether the inputted second authentication information corresponds to the first authentication information and, if the inputted second authentication information corresponds to the first authentication information, a print processing is performed on the basis of the print data.

19. The printing-apparatus control method according to claim 18, further comprising accepting an input of a predetermined condition,
wherein, in the displaying step, a list of information about the print data satisfying the predetermined condition accepted in the condition-input accepting step is displayed.

20. The printing-apparatus control method according to claim 19, wherein the predetermined condition includes at least one of a user name, authentication information, and a print data name.

21. A computer-readable recording medium containing computer-executable instructions for allowing a printing apparatus to perform secure printing procedures, the medium comprising:
computer-executable instructions for generating first authentication information corresponding to inputted print data on the basis of predetermined information;
computer-executable instructions for storing the first authentication information and the print data in a holding unit;
computer-executable instructions for accepting an input of second authentication information; and
computer-executable instructions for controlling a print processing such that a determination is made, on the basis of the first authentication information, whether the inputted second authentication information corresponds to the first authentication information and, if the inputted second authentication information corresponds to the first authentication information, the print processing is performed on the basis of the print data authentication,
wherein the predetermined information includes specific information accompanying the print data.
